(19) United States
(12) Patent Application Publication
(10) Pub. No.: US 2008/0020745 A1
(43) Pub. Date: Jan. 24, 2008

(54) Method and apparatus for supporting communication service of idle user terminal located in common routing area in a mobile communication system

(75) Inventors: Eun-Hui Bae, Seoul (KR); Sung-Ho Choi, Suwon-si (KR); O-Sok Song, Suwon-si (KR); No-Jun Kwak, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/784,114

(22) Filed: Apr. 5, 2007

(30) Foreign Application Priority Data
Apr. 5, 2006 (KR) 2006-31145

(51) Int. Cl. H04Q 7/20

(52) U.S. Cl. 455/422.1

(57) ABSTRACT

A method for supporting a communication service of an idle mode terminal located in a common routing area in a mobile communication system that includes a Node B, an Access Gateway (AGW), and a Home Subscriber Server (HSS), and has a Long Term Evolution (LTE) network and a 3^{rd} Generation (3G) network connected to each other to perform transmission/reception. The AGW receives tracking area information of the LTE network, including routing area information of the 3G network, from the idle mode terminal via the Node B. The AGW sends common routing area indication information and identification information of the terminal to the HSS if the routing area information is coincident with the tracking area information. The HSS stores the common routing area indication information and the identification information of the terminal, and sends a response message according to the indication information.

### PRIORITY

This application claims priority under 35 U.S.C. §119(a) to a Korean Patent Application filed in the Korean Intellectual Property Office on Apr. 5, 2006 and assigned Serial No. 2006-31145, the disclosure of which is incorporated herein by reference.

### BACKGROUND OF THE INVENTION

1. Field of the Invention

The present invention relates generally to a mobile communication system, and in particular, to an apparatus and method for registering terminal information when a terminal in an idle mode is located in a common routing area. In addition, the present invention relates to a method and apparatus in which a terminal that has ever forwarded a voice call being delivered to a specific terminal located in a routing area, to the specific terminal via an IP Multimedia Subsystem (IMS) network and a Long Term Evolution (LTE) network, or ever received a voice call via the IMS network and the LTE network, can seamlessly receive the voice call over the IMS network and the LTE network even when it moves to a 3^{rd} Generation (3G) network.

2. Description of the Related Art

The 3^{rd} Generation Partnership Project (3GPP) is in charge of Universal Mobile Telecommunications System (UMTS) standardization. In 3GPP, Long Term Evolution (LTE) is now under discussion as the next generation mobile communication system of the UMTS system. LTE, aiming for deployment in about 2010, is technology for implementing high-speed packet based communication at approximately 100 Mbps. To this end, several schemes are under discussion, and for example, those schemes include one scheme for reducing the number of nodes located in a communication path by simplifying the network configuration, and another scheme for maximally approximating wireless protocols to wireless channels. As a result, it is expected that the LTE configuration will change from the existing 4-node configuration to a 2-node or 3-node configuration.

The LTE network with the simple node configuration, as it interworks with the existing 3G network, can exchange voice and data with an existing user terminal, guaranteeing backward compatibility.

FIG. 1 illustrates a connection configuration between an LTE network and a 3G network in a mobile communication system.

Referring to FIG. 1, the illustrated configuration provides Circuit Switched (CS) voice services and Packet Switched (PS) data services to a terminal 105, or User Equipment (UE), based on a 3G-UMTS network 110, an LTE-Evolved UMTS (LTE-EUMTS) network 155, and an IMS network 135.

Specifically, when the terminal 105 exists in a 3G network 110, the terminal 105, for exchanging CS calls with a CS Core Network (CN) 130, sends signaling to a Radio Network Controller (RNC) 115 connected to the terminal 105, among a plurality of RNCs connected to an Gateway Mobile Switching Center (GMSC) 125 in the 3G network 110. The GMSC 125 can acquire information on the terminal 105 through a Home Subscriber Server (HSS) 150.

As for a PS call, an IMS network 135 is connected to a Serving GPRS Support Node (SGSN) 120 in the 3G network 110, and the RNC 115 forwards a received PS call delivered from the SGSN 120 to the terminal 105.

The LTE network 155 includes an Access Gateway (AGW) 160 and an Evolved Node B (ENB) 165. The AGW 160 corresponds to a Core Network Entity that takes charge of a User Plane Control function (for example, Gateway GPRS Support Node (GGSN)) and a Control Plane Control function (for example, SGSN). The ENB 165, a node corresponding to the existing Node B, is connected to the terminal 105 over a wireless channel. Compared with the existing Node B, the ENB 165 performs a complex function.

In LTE, all user traffic including real-time services, such as Voice over Internet Protocol (VoIP) will be serviced over shared channels, and this means that there is a need for an apparatus of collecting status information of terminals 105 and performing scheduling depending thereon. The scheduling is managed by the ENB 165.

The IMS network 135 includes Call Session Control Functions (CSCFs) 140 and interworking entities 145.

The CSCFs 140 include a Serving-Call Session Control Function (S-CSCF) in charge of SIP-based call setup to a terminal operating based on Session Initiation Protocol (SIP), a Proxy-Call Session Control Function (P-CSCF) in charge of Signaling Control with the 3G-UMTS network 110 and the LTE-EUMTS network 155, and an Interrogating-Call Session Control Function (I-CSCF) in charge of performing search of the S-CSCF and hiding the IMS network 135 from the external network. The interworking entities 145 include a Switching Gateway (SGW) in charge of interworking with CS Signaling and IMS Signaling, and a Media Gateway Control Function (MGCF).

When the terminal 105 moves from the 3G network 110 to the LTE network 155 (PS-only network) based on the network shown in FIG. 1, a CS voice call being delivered to the terminal 105 will be converted into a PS data call before delivery. Similarly, when the terminal 105 moves from the LTE network 155 to the 3G network 110, a PS data call being delivered to the terminal 105 via the LTE network 155 will be converted into a CS voice call through a Circuit Switched Core Network (CS CN) 130 of the 3G network, or converted into a PS data call through a Packet Switched Core Network (PS CN) of the 3G network before the delivery to the terminal 105.

In this system configuration, when a terminal is in an idle state and is currently located in the physically same area for the 3G network and the LTE network, i.e. when a routing area (RA) in the 3G network and a tracking area in the LTE network are located in the same common routing area (or Common RA), if the terminal frequently performs routing area update (i.e. moves from the LTE network to the 3G network) and/or tracking area update (i.e. moves from the 3G network to the LTE network) within coverage of the common routing area, conversion of a CS voice call being delivered to the terminal into a PS call and/or conversion of a PS call based on the LTE network into a PS call based on the 3G network are continuously performed.

In the foregoing conventional mobile communication network system, there is a need for a scheme of realizing the concept of the common routing area for minimizing unnecessary signaling due to movement in the area where frequent inter-system change occurs as the system is generally established in the boundary between the LTE network and the 3G network. In addition, due to the characteristics of the CS voice call supportable in the 3G network, in order to process a CS call in the common routing area proposed for reducing signaling for mobility control due to the movement of the terminal, additional signaling is needed undesirably.

### SUMMARY OF THE INVENTION

An aspect of the present invention is to address at least the problems and/or disadvantages above and to provide at least the advantages described below. Accordingly, an aspect of the present invention is to provide a method and apparatus for registering a mobile terminal in a common routing area to minimize unnecessary signaling due to movement in an area where frequent inter-system change occurs in a mobile communication network system established in the boundary between an LTE network and a 3G network.

Another aspect of the present invention is to provide a method and apparatus for delivering a voice call to a terminal when a tracking area for a terminal in an idle mode in an LTE network and a routing area for a terminal in an idle mode in a 3G network are equal to each other.

Another aspect of the present invention is to provide a method and apparatus capable of always receiving a PS call via an LTE network, for a CS voice call, to reduce interworking overhead for the CS call and the PS call when system change occurs from a 3G network to the LTE network or from the LTE network to the 3G network as movement occurs in a common routing area after a terminal accesses the LTE network, or even when a CS call can be received through a CS connection of the 3G network.

Another aspect of the present invention is to provide a method and apparatus for converting all CS voice calls being delivered to a terminal into PS data calls before delivery by registering, in an HSS, a terminal, if any, located in a common routing area in a mobile communication system.

According to one aspect of the present invention, there is provided a method for supporting a communication service of an idle mode terminal located in a common routing area in a mobile communication system that includes a Node B, an Access Gateway (AGW), and a Home Subscriber Server (HSS), and has a Long Term Evolution (LTE) network and a 3^{rd} Generation (3G) network connected to each other to perform transmission/reception. The method includes receiving, by the AGW, tracking area information of the LTE network, including routing area information of the 3G network, from the idle mode terminal via the Node B; sending, by the AGW, common routing area indication information and identification information of the terminal to the HSS if the routing area information is coincident with the tracking area information; and storing, by the HSS, the common routing area indication information and the identification information of the terminal, and sending a response message according to the indication information.

According to another aspect of the present invention, there is provided a apparatus for supporting a communication service of an idle mode terminal located in a common routing area in a mobile communication system in which a Long Term Evolution (LTE) network and a 3^{rd} Generation (3G) network are connected to perform transmission/reception. The apparatus includes a Home Subscriber Server (HSS) for performing tracking area update to register routing area information of the LTE network and storing common routing area information; an Access Gateway (AGW) for receiving, from the terminal, tracking area information of the LTE network, including routing area information of the 3G network from the idle mode terminal, comparing the routing area information with the tracking area information, and sending common routing area indication information and identification information of the terminal to the HSS if the routing area information is coincident with the tracking area information; and the HSS for storing the common routing area information and the identification information of the terminal, and sending a response message according to the common routing area indication information.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating a connection configuration between an LTE network and a 3G network in a mobile communication system;

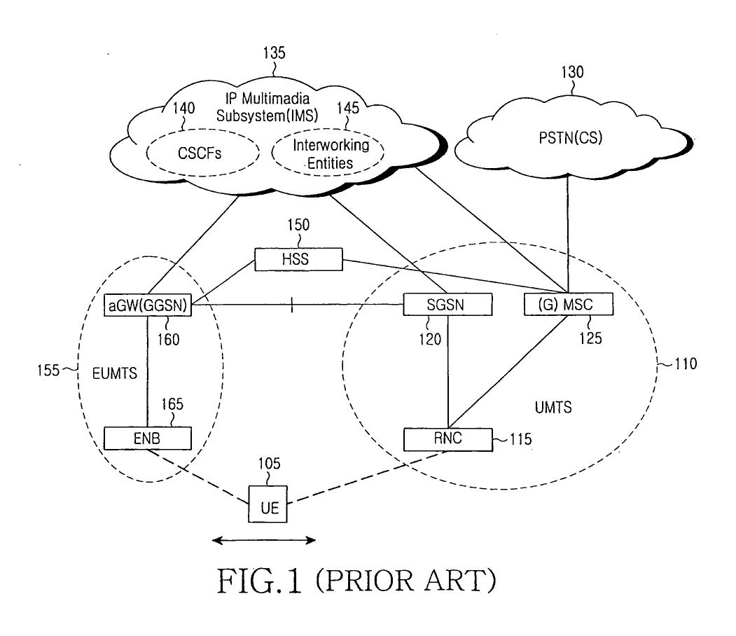

FIG. 2 is a diagram illustrating a process of registering common routing area information in an HSS according to a preferred embodiment of the present invention;

FIG. 3 is a diagram illustrating a call reception procedure of a terminal in a mobile communication system in which an LTE network and a 3G network are connected according to a preferred embodiment of the present invention; and

FIG. 4 is a diagram illustrating a process of converting a CS call into a PS call and delivering the PS call to an idle terminal via an IMS network according to a preferred embodiment of the present invention.

### DETAILED DESCRIPTION OF EXEMPLARY EMBODIMENTS

Exemplary embodiments of the present invention will now be described in detail with reference to the annexed drawings. In the following description, a detailed description of known functions and configurations incorporated herein has been omitted for clarity and conciseness.

The present invention provides a method and apparatus for delivering a voice call to a terminal when a tracking area (or routing area) for a terminal in an idle mode (or sleep mode) in an LTE network and a routing area for a terminal in an idle mode in a 3G network are equal to each other, i.e. when a terminal in the idle mode is located in a common routing area.

In addition, the present invention provides a method and apparatus in which after the time a terminal has attached to (or accessed) an LTE network or after the time the terminal has moved to the LTE network, converted a CS call being delivered thereto into a PS call and then received the PS call, the terminal can always receive the CS voice call via the LTE network to reduce interworking overhead for a CS call and a PS call, even in the situation where the terminal can receive the CS call via a CS connection of a 3G network, while maintaining the CS connection and a PS connection of the 3G network as system change occurs from the 3G network to the LTE network or from the LTE network to the 3G network due to movement of the terminal in a common routing area.

Further, the present invention provides a method and apparatus in which when a terminal is located in a common routing area, a network (for example, HSS) maintains information indicating the presence of the terminal in the common routing area, thereby enabling automatic conversion of a CS voice call being delivered to the terminal into a PS data call when the terminal is located in an LTE network. In addition, as for a terminal that has converted a CS voice call into a PS data call and received the PS data call through the LTE network, the terminal can seamlessly convert the CS voice call into the PS data call and receive the PS data call through the LTE network using common routing area information of the terminal, being maintained in the HSS, even when the terminal moves from the LTE network to the 3G network. The scheme of maintaining Common RA information through the HSS provides a scheme for efficiently processing the CS voice call and also allows seamless connection of the CS connection and the PS connection of the 3G network for smooth delivery of voice/packet data to the terminal as the terminal moves from the 3G network to the LTE network, thereby reducing overhead for connection reset and security reset due to the frequently occurring movement between the LTE network and the 3G network.

To this end, an embodiment of the present invention provides one scheme of registering, in an HSS, common routing area information of a terminal when the terminal accesses an LTE network, or when the terminal in an idle mode moves from a 3G network to the LTE network, and another scheme of converting a CS voice call into a PS data call through an IMS network and the LTE network using the information stored in the HSS.

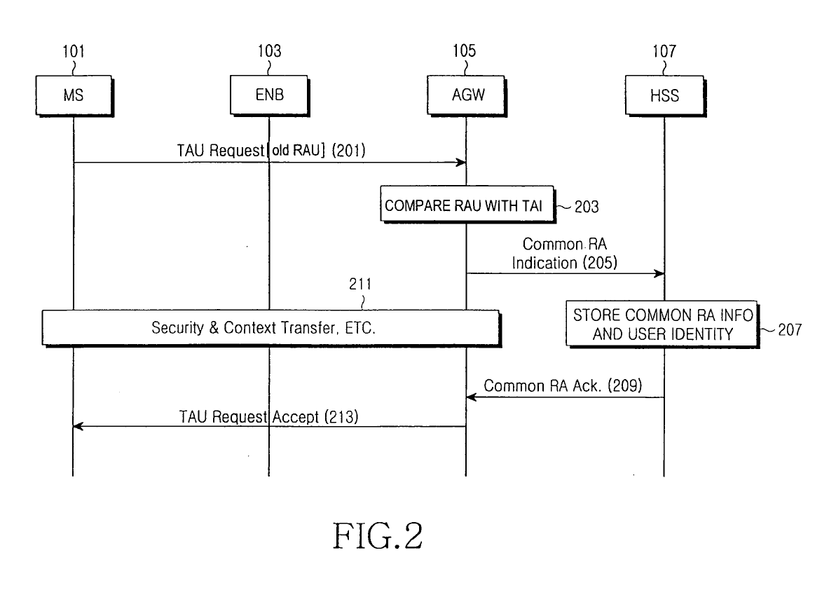

FIG. 2 illustrates a process in which a terminal registers, in an HSS, common routing area information through an access process or a tracking area update process according to a preferred embodiment of the present invention.

Referring to FIG. 2, when a terminal 101 (or a Mobile Station (MS)) in an idle mode, located in a 3G network, moves to an LTE network, the terminal 101 sends in step 201 a Tracking Area Update (TAU) Request message to an AGW 105, which is an LTE core network entity, in order to perform a TAU (or Routing Area Update (RAU)) process. The TAU Request message includes information on a routing area in the 3G network.

Upon receipt of the TAU Request message, the AGW 105 compares, in step 203, its current tracking area information (TAI) with routing area information (RAI) in the 3G network, sent by the terminal 101. If the tracking area information is coincident with the routing area information, the AGW 105 sends in step 205, to an HSS 107, common routing area indication information for indicating the coincidence between the routing area and the tracking area for the terminal 101. The common routing area indication information can be individually sent to the HSS 107 over a separate message, or the indication information can be added to an existing message (for example, Update Location message) for registering information of the AGW 105 in the HSS 107 and then registered in the HSS 107.

Upon receipt of the common routing area indication information indicating that both the 3G network and the LTE network are serviceable in the current location of the terminal 101, the HSS 107 stores in step 207 the common routing area indication information and user Identity (ID) information included together with the indication information. The HSS 107 sends in step 209 a response message (or Ack message) for the common routing area indication information to the AGW 105.

The response message for the common routing area indication information is optional, and when the common routing area indication information is piggybacked on the existing message, it follows an operation of a response message (for example, Location Update Accept message) for the existing message. If information (for example, information on an MSC 113 or information on an SGSN) on the 3G network of the terminal 101, which has sent to the HSS 107 the indication information indicating that the terminal 101 is currently located in the common routing area, is stored, the HSS 107 additionally stores the common routing area indication information of the terminal 101 without deleting the existing registration information for the terminal 101. On the contrary, if the common routing area indication information is not sent to the HSS 107, the HSS 107 should delete the previously stored common routing area indication information for the corresponding terminal. A security-related operation and a context transfer operation of step 211 occurring in a TAU process, and a Tracking Area Update Accept process of step 213 follow the existing scheme or a scheme defined in LTE, and a description thereof will be omitted herein because they are not related to the present invention.

Although the scheme of registering common routing area information in the HSS 107 in the tracking area update process has been described herein, the terminal can register the common routing area information in the HSS 107 in the same manner using the foregoing operations, through a process of first accessing the LTE network.

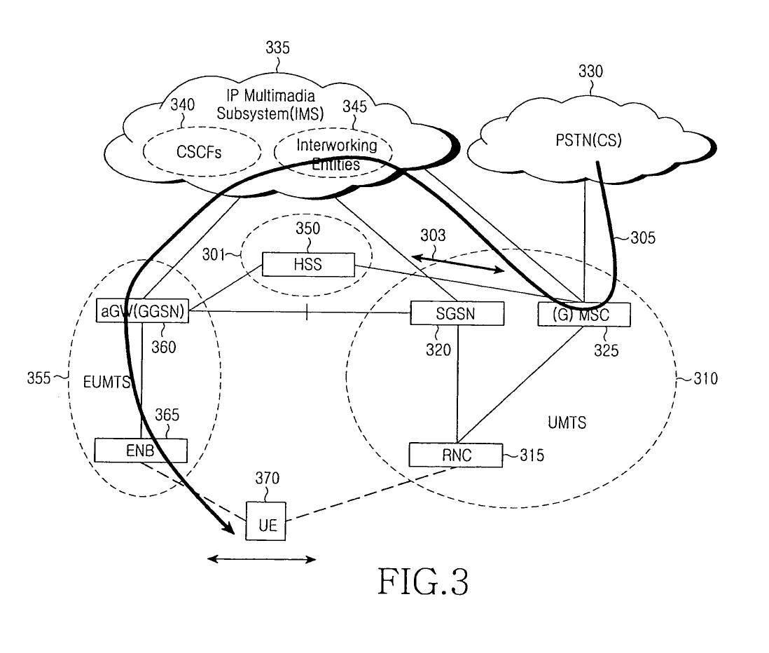

In the conventional method, if TAU is completed after movement from the 3G network to the LTE network, the HSS deletes information on a CS network of the 3G network, i.e. information on both a connection and a PS network. Therefore, if the terminal moves back to the 3G network later, the conventional method must re-perform the process of registering in the HSS the information necessary for security setting and connection setting. Thus, in FIG. 3, if the terminal is located in a specific area called a Common RA, the information indicating that the terminal is located in the Common RA is registered in the HSS to make the best use of the characteristics of this area, thereby reducing additional processing.

FIG. 3 illustrates a call reception procedure of a terminal in a mobile communication system in which an LTE network and a 3G network are connected according to a preferred embodiment of the present invention.

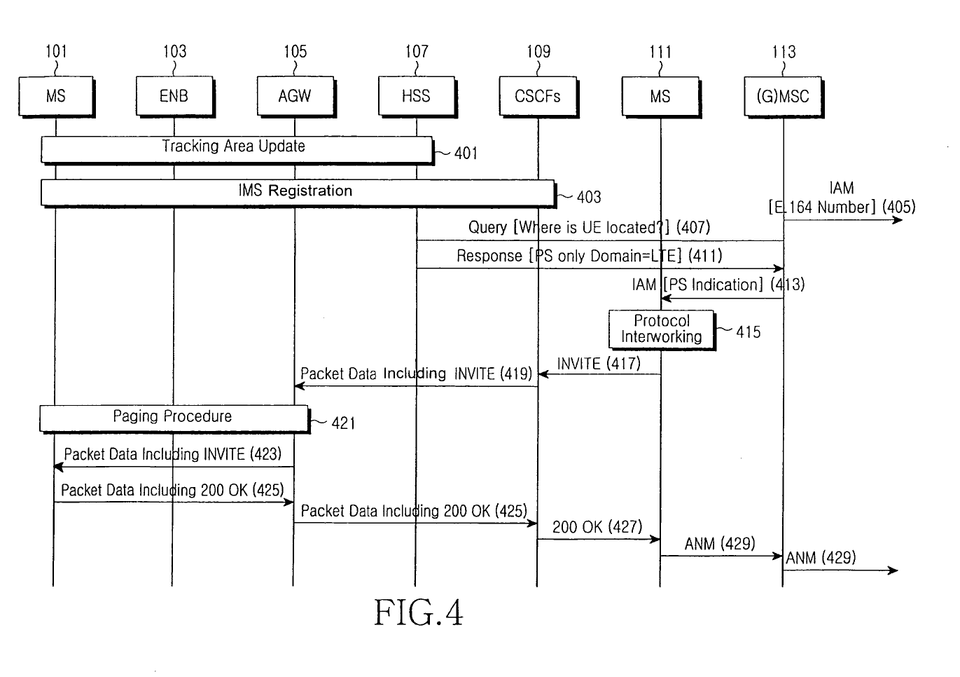

Referring to FIG. 3, an HSS 350 stores in step 301 common routing area information through the tracking area update process described in FIG. 2, and sends in step 303 common routing area indication information to an MSC 325. The common routing area indication information sent from the HSS 107 to the (G)MSC 113 (325) is information indicating that a CS voice call being delivered to the terminal should be sent via the LTE network. This information can be an indication interpretable in the MSC 113 (see FIG. 4), or can be an address for call delivery to the LTE network.

Thereafter, if the MSC 325 receives in step 305 a CS voice call signal from a CS 330, it sends information ordering conversion from a CS call to a PS call to interworking entities 345 of an IMS network 335 based on the received common routing area indication information, and the interworking entities 345 send an INVITE message to a CSCF 340 after the call conversion. The CSCF 340 sends the INVITE message to an AGW 360 along with the packet data being exchanged with an LTE network 355.

A paging procedure is performed between the AGW 360 and a terminal 370 to exchange packet data including the INVITE message. As a result, the CS voice call signal received at the MSC 325 is converted into a PS call and then delivered to the terminal 370 without system modification while the terminal 370 moves in the common routing area.

FIG. 4 illustrates a process of converting a CS voice call being delivered to a terminal into a PS data call through an IMS network and an LTE network before delivery, using common routing area information registered in an HSS through a tracking area update process according to a preferred embodiment of the present invention.

If a terminal 101 in an idle state, located in a 3G network, moves to an LTE network, the terminal 101 performs in step 401 a tracking area update process to the LTE network. A scheme of registering, in an HSS, location information of the terminal, i.e. common routing area information, through the tracking area update has been described with reference to FIG. 2. The process in step 401 sends context information such as QoS and security information of the terminal from the 3G network to the LTE network, sets up a radio connection between the terminal 101 and an ENB 103, and sets up a bearer between the ENB 103 and an AGW 105. After completion of step 401, the terminal 101 performs in step 403 authentication on an IMS network and an IMS registration process for registering, in an HSS 107, terminal ID information (for example, Public User Identity and Private User Identity) to be used in the IMS network, and an S-CSCF 109 for the terminal 101.

The IMS registration process of step 403 is equal to the operation specified in 3GPP TS23.228 (IP Multimedia Subsystem; Stage 2) and TS24.229 (IP multimedia call Control protocol based on SIP and Session Description Protocol (SDP); Stage 3), so an additional description thereof will be omitted.

If an Initial Address Message (IAM) message, a request message for setting up a CS call to the terminal 101 that has moved to the LTE network, is sent in step 405, the CS CN entity (or (G)MSC) 113 in the 3G network, receiving the IAM message, sends a Query message for routing information to the HSS 107 in step 407 to detect the current location information of the terminal 101. Because the information indicating that the terminal 101 is located in the common routing area and the CS voice call for the corresponding terminal 101 should be converted into the PS data call, has already been registered in the HSS 107 through the tracking area update process of step 401, the CS-to-PS conversion information is sent to the (G)MSC 113 in the 3G network using a Response message in step 411. From the Response message, the (G)MSC 113 acquires information indicating that it should send to the terminal 101 a CS call setup request message (shown in step 405) to the terminal 101 via the IMS network and the LTE network, i.e. the AGW 105.

To this end, the 3G (G)MSC 113 sends an IAM message, which is a CS call setup request message, to interworking entities 111 (for example, MGCF (Media Gateway Control Function) and SGW (Service Gateway) in the IMS network in step 413. A scheme of sending the IAM message from the 3G (G)MSC 113 to the interworking entities 111 follows the method defined in 3GPP TS29.163 (Interworking between the IMS and CS networks), and a detailed description thereof will be omitted herein because it is not related to the present invention. Upon receiving the IAM message or the CS call setup request message, the interworking entities 111 in the IMS network perform in step 415 an operation of converting a CS message into an IMS Session Initiation Protocol (SIP) message.

An INVITE message, which is an SIP-based call (or session) setup request message generated by the interworking entities 111, is sent to the S-CSCF/P-CSCF 109 in step 417, and the INVITE message is sent to the AGW 105, which is a CN entity of the LTE network, in the IP packet format in step 419. Upon receipt of packet data including the SIP INVITE message, the AGW 105, recognizing that the terminal 101 is in the idle state, performs in step 421 a paging procedure for detecting an accurate location of the terminal 101 through a process of broadcasting a Paging Request message to the corresponding tracking area and receiving a Paging Response message to detect the accurate location in the LTE network, and reestablishing a bearer.

After detecting the location of the terminal 101 and establishing a bearer for packet data delivery through the paging procedure of step 421, the AGW 105 sends packet data including an INVITE message to the terminal 101 in step 423. Upon receipt of the packet data, the terminal 101 sends a 200 OK response message for the call setup to the AGW 105 along with packet data and the AGW 105 forwards the 200 OK message to the P-CSCF/S-CSCF 109, in step 425. Upon receipt of the 200 OK message, the P-CSCF/S-CSCF 109, which is an IMS entity, forwards the 200 OK message to the interworking entities 111 in step 427 to covert the 200 OK message into an ISDN User Part (ISUP) message. Through the interworking entities 111, the 200 OK message is converted into an Answer Message (ANM), or an ISUP message, and then sent to the called party via a CS network in step 429.

As can be understood from the foregoing description, when a terminal is located in a common routing area, the present invention registers the corresponding information in an HSS to convert all CS voice calls being delivered to the terminal into PS data calls before delivery, thereby reducing overhead of the procedure for converting the CS voice calls into the PS data calls, which may incidentally occur due to the frequent movement of the terminal in the common routing area. In addition, when a terminal is located in a common routing area, the present invention registers the corresponding information in an HSS to maintain the CS connection information and PS connection information of the 3G network for the corresponding terminal without deleting the information, thereby reducing overhead of the procedure for CS connection and PS connection reestablishment of the 3G network, and security reestablishment for the HSS, which may incidentally occur due to the frequent movement of the terminal in the common routing area.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for supporting a communication service of an idle mode terminal located in a common routing area in a mobile communication system that includes a Node B, an Access Gateway (AGW), and a Home Subscriber Server (HSS), and has a Long Term Evolution (LTE) network and a 3^{rd} Generation (3G) network connected to each other to perform transmission/reception, the method comprising:
receiving, by the AGW, tracking area information of the LTE network, including routing area information of the 3G network, from the idle mode terminal via the Node B;
sending, by the AGW, common routing area indication information and identification information of the terminal to the HSS if the routing area information is coincident with the tracking area information; and
storing, by the HSS, the common routing area indication information and the identification information of the terminal, and sending a response message according to the indication information.

2. The method of claim 1, further comprising:
sending, by the HSS, indication information indicating that a Circuit Switched (CS) voice call to the terminal should be delivered via the LTE network, in response to a location confirm request of the terminal for delivering a CS voice call from the 3G network; and
converting a CS voice call of the 3G network into a Packet Switched (PS) call of the LTE network based on the indication information before call delivery.

3. The method of claim 1, wherein the common routing area indication information is information indicating that a CS voice call of the 3G network is always converted into a PS call of the LTE network for call service.

4. The method of claim 2, further comprising:
after receiving the indication information, maintaining CS connection information and PS connection information of the 3G network without deleting the information.

5. An apparatus for supporting a communication service of an idle mode terminal located in a common routing area in a mobile communication system in which a Long Term Evolution (LTE) network and a 3^{rd} Generation (3G) network are connected to perform transmission/reception, the apparatus comprising:
a Home Subscriber Server (HSS) for performing tracking area update to register routing area information of the LTE network and storing common routing area information;
an Access Gateway (AGW) for receiving, from the terminal, tracking area information of the LTE network, including routing area information of the 3G network from the idle mode terminal, comparing the routing area information with the tracking area information, and sending common routing area indication information and identification information of the terminal to the HSS if the routing area information is coincident with the tracking area information; and
the HSS for storing the common routing area information and the identification information of the terminal, and sending a response message according to the common routing area indication information.

6. The apparatus of claim 5, further comprising a Mobile Switching Center (MSC) for sending Packet Switched (PS) indication information to an interworking entity so as to convert a voice call of the 3G network into a PS call of the LTE network based on indication information, received from the HSS, indicating that a Circuit Switched (CS) voice call to the terminal is delivered via the LTE network.

7. The apparatus of claim 5, wherein the common routing area indication information is information indicating that a CS voice call of the 3G network is always converted into a PS call of the LTE network for call service.

8. The apparatus of claim 5, wherein after receiving the indication information, the HSS maintains CS connection information and PS connection information of the 3G network without deleting the information.
